(19) United States
(12) Patent Application Publication
(10) Pub. No.: US 2016/0038853 A1
(43) Pub. Date: Feb. 11, 2016

(54) APPARATUS AND METHODS FOR CONTROLLING THE TEMPERATURE OF A CHROMATOGRAPHY COLUMN

(71) Applicant: WATERS TECHNOLOGIES CORPORATION, Milford, MA (US)

(72) Inventor: Joshua A. Shreve, Franklin, MA (US)

(73) Assignee: WATERS TECHNOLOGIES CORPORATION, Milford, MA (US)

(21) Appl. No.: 14/779,496

(22) PCT Filed: Mar. 26, 2014
(86) PCT No.: PCT/US14/31820

§ 371 Date: Sep. 23, 2015

Related U.S. Application Data
(60) Provisional application No. 61/816,943, filed on Apr. 29, 2013.

(51) Int. Cl. B01D 15/16; B01D 15/22; G01J 5/10; B01D 15/20; G01N 30/30; G01J 5/00

(52) U.S. Cl. CPC B01D 15/161; G01N 30/30; G01J 5/0003; G01J 5/10; B01D 15/20; B01D 15/22

(57) ABSTRACT

An apparatus for controlling the temperature of a chromatography column includes a thermal-isolation vessel; a heater in thermal communication with the chromatography column and disposed on the thermal-isolation vessel; a temperature sensor disposed to directly measure the temperature of the chromatography column; and a control unit in signal communication with the temperature sensor to control the heater in response to LIGHT the direct measurement.

### RELATED APPLICATIONS

This application claims priority to and the benefit of U.S. Provisional Application Ser. No. 61/816,943, filed Apr. 29, 2013, the entirety of which is incorporated herein by reference.

### BACKGROUND

It is known in the art of chromatography that the temperature of a column affects the retention time and bandwidth of chromatographic peaks of compounds being separated by the column. Thus, accurate measurement and control of the column temperature are critical for quality and reproducibility of chromatographic separations.

A widely accepted approach to controlling the temperature of a column is through at least one heater that is in thermal communication with the column, where the temperature of the heater is controlled at a set point and regularly measured and monitored during a chromatographic operation. For example, the heater can be operated to heat the column until thermal equilibrium between them is reached, i.e., when the temperature of the column reaches the same as that of the heater and hence the same as the set point. From then on, the column temperature will presumably stay at the set point, assuming that the thermal equilibrium between the column and the heater will persist and not be perturbed for the rest of the operation.

However, those assumptions hardly hold in real-world chromatography applications, as perturbations to the thermal equilibrium do certainly occur, e.g., due to internal heat generated from flow resistance of a fluid passing through the column or heat loss to the surrounding system, causing temperature variations across the column end to end.

### SUMMARY

Some embodiments arise, in part, from the realization that an apparatus can advantageously be configured to directly measure the temperature of a chromatography column. Direct readings of the column temperature permit, for example, improved control of heaters that do not directly heat the column.

One embodiment provides an apparatus that provides improved control of the temperature of a chromatography column. The apparatus includes a thermal-isolation vessel, a heater in thermal communication with the chromatography column, a temperature sensor disposed to directly measure the temperature of the chromatography column, and a control unit in signal communication with the temperature sensor to control the heater in response to the direct measurement.

Another embodiment provides a method of controlling the temperature of a chromatography column. The method includes directly measuring the temperature of the chromatography column and heating a solvent in response to the measured temperature to control the temperature of the chromatography column.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1 is a schematic overview of an apparatus for controlling the temperature of a chromatography column, including a thermal-isolation vessel, a heater, a temperature sensor and a control unit, in accordance with one embodiment of the invention.

FIG. 2 is a schematic view of a related embodiment to that of FIG. 1, wherein additional temperature sensors are used to directly measure the temperature of the chromatography column.

FIG. 3 is a schematic view of an embodiment of the control unit of FIG. 1.

FIG. 4 is a flow diagram of a method for controlling the temperature of a chromatography column using the apparatus of FIG. 1.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

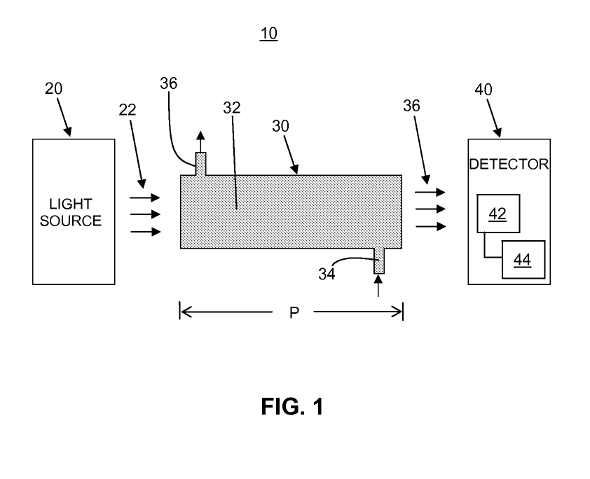

Referring to FIG. 1, an apparatus 100 for controlling the temperature of a chromatography column 110 includes a thermal-isolation vessel 120, a heater 130, a temperature sensor 140 and a control unit 150.

The chromatography column 110 can be a liquid chromatography (LC), gas chromatography (GC) or a supercritical fluid chromatography (SFC) column, and can be fabricated in any desired form, such as a column, a tile, a chip or a cartridge, packed with separation media of any suitable sizes. The chromatography column 110 is disposed within the thermal-isolation vessel 120 and in thermal communication with the heater 130.

The thermal-isolation vessel 120 has a hollow body in a rectangular shape, within which the column 110 is disposed. The thermal-isolation vessel 120 can include an insulating material to reduce heat loss from the chromatography column 110 to help maintain a desired column temperature. As shown in FIG. 1, the thermal-isolation vessel 120 also contains a pre-heater A, which heats a fluid prior to its entry into the chromatography column 110. The pre-heater A has a body defining a transverse fluidic channel (not shown) for a fluid to pass therethrough to be pre-heated before the fluid is directed to the column 110.

The heater 130 is disposed within the thermal-isolation vessel 120 to heat the vessel 120 to a set temperature. The term “heater,” as used herein, in its broadest sense, refers to any device that can be operated to heat or cool a target to a desired temperature, and, accordingly, the term “heating,” as used herein, refers to operation of either heating or cooling. The heater 130 can be a heated plate or trough around the column 110 or a heater with fans that circulate hot air along the surface of the column 110. The column 110 can also be heated by a heated fluid from the pre-heater A or by an induction heater, an infrared heater, or any other suitable heater known in the art.

In some implementations, the pre-heater A, in conjunction with the heater 130, also contributes in controlling the temperature of the column 100, in which case, the temperature of the pre-heater A is set to match the set point of the heater 130 and regularly monitored during a chromatographic operation. A fluid, e.g., a liquid mobile phase or a sample solution, flows through the transverse fluidic channel defined by the pre-heater A and is pre-heated to the set temperature; the pre-heated fluid flows into the chromatography column 110 and transfers heat to the column 110 until thermal equilibrium between the fluid and the column 110 is reached. The pre-heater A can be connected to the chromatography column 110 through a tube extending from the transverse fluidic channel of the pre-heater A.

The temperature sensor 140 disposed within the thermal-isolation vessel 120 directly measures the temperature of the chromatography column 110. The sensor 140 can be either a contact sensor or a non-contact sensor. The term “contact sensor,” as used herein, refers to a sensor that measures its own temperatures that are presumably the same as the temperature of a target under measurement, assuming that thermal equilibrium between the target and the sensor is reached. A contact sensor can thermally communicate with a target through direct physical contact or across a medium which is in direct contact with both the target and the sensor. Commonly used contact sensors include, but are not limited to, thermistors, thermocouples, etc. The term “non-contact sensor,” as used herein, refers to a sensor that measures electromagnetic radiation emitted from surfaces of a target. A non-contact sensor can be any type of pyrometer, for example, an infrared (IR) sensor. An IR sensor measures IR energy radiated from a target in the field of view defined by the sensor's optics and locations, converts the IR energy to an electrical signal and transforms the electrical signal to a temperature value, based on the target material's optical property or emissivity, which is a ratio of energy radiated by a target to energy radiated by a black body at the same temperature. Other types of non-contact sensors include, but are not limited to, radiation thermometers, thermal imagers, line scanners, optical pyrometers, fiber optical sensors, etc.

If the temperature sensor 140 is a contact sensor, an electric circuit is normally built inside the thermal-isolation vessel 120 or on a surface of the chromatography column 110 through which the control unit 150 can electrically communicate with the contact sensor 140 to determine therefrom the temperature of the chromatography column 110. The contact sensor 140 can be attached to or mounted on the column 110.

If the temperature sensor 140 is a non-contact sensor, it need not to be in direct contact with the chromatography column 110 and can be installed anywhere around the apparatus 100 but preferably disposed within the thermal-isolation vessel 120. If the non-contact sensor 140 is an IR sensor, the chromatography column 110 is preferably made of a material of known emissivity, e.g., stainless steel, or covered by a material of known emissivity at a surface area to be targeted. The IR sensor 140 is preferably protected by an IR-transmissive material, which ought to be optically inactive over a range of IR wavelengths, typically from greater than about 700 nm to less than about 10⁶ nm. Examples of IR-transmissive materials include silicon dioxide (quartz), fused silica, PEEK® polymer, polytetrafluoroethylene (Teflon®PTFE), polyimide (PI), polyethylene (PE), or polypropylene (PP), or any combination thereof.

The control unit 150 can include any commonly used computing system, which include, but are not limited to, embedded processors, personal computers, server computers, hand-held or laptop devices, multiprocessor systems, microprocessor-based systems, programmable consumer electronics, minicomputers, mainframe computers and the like known in the art.

The control unit 150 receives temperature signals from the temperature sensor 140. If the temperature signals indicate a deviation in the temperature of the column 110 from a set point, the control unit 150 will adjust the temperature of the heater 130 and/or the pre-heater A, thereby modifying the temperature of the column 110 to maintain the column 110 at the set point.

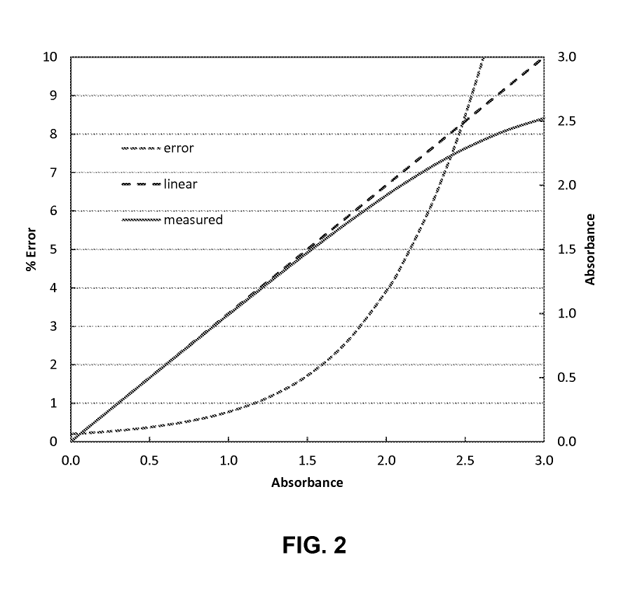

FIG. 2 is a schematic view of an apparatus 100, similar to that of FIG. 1, but including additional temperature sensors 140 to directly measure the temperature of the column 110. The additional temperature sensors 140 can be either contact sensors or non-contact sensors and can measure the temperature of the chromatography column 110 at multiple locations. When more than one temperature sensor 140 is employed, they can be distributed evenly along the length of the column 110, as shown in FIG. 2. The direct measurements at multiple locations produce a plurality of temperature signals that are outputted to the control unit 150 for processing, and an average temperature of the signals is normally of interest. If only one temperature sensor 140 is used, it can target the middle of the column 110 to measure the temperature thereof, as shown in FIG. 1. The average temperature and the middle temperature are generally comparable. In some embodiments, the temperature of the column 110 can be measured at a plurality of locations along the column using one or more of temperature sensors 140 that can physically move or be moved relative to the column 110 to measure the temperature of the column 110 at different locations.

If the plurality of temperature signals received by the control unit 150 indicates a change in the column temperature from a set point, the control unit 150 will control operation of the heater 130 and/or the pre-heater A to adjust the temperature thereof. In some implementations, the control unit 150 will first take an average of the plurality of temperature signals, compare the average with a set point and a threshold value, and then modify the temperature of the heater 130 and/or the pre-heater A, based on the comparison.

In some implementations, each of sensor(s) can have its own display and user interface, providing the user an option to manually operate the heater 130 and/or the pre-heater A, based on the temperature values displayed thereon.

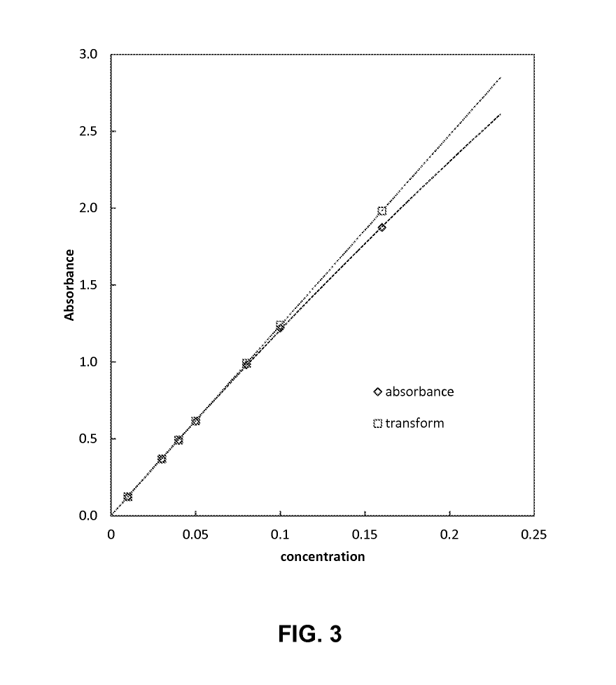

FIG. 3 illustrates a preferred embodiment of the control unit 150 of FIG. 1, which has a control loop including three proportional-integral-derivative controllers (PIDs). One of the PIDs is in signal communication with the temperature sensor 140, which is directly measuring the temperature of the chromatography column 110. The other two PIDs communicate, respectively, with the heater 130 and the pre-heater A. In some implementations, the heater 130 and the pre-heater A each include at least one temperature sensor to measure the temperature thereof and to feedback each of the PIDs included in the control unit 150 with one or more temperature signals. The PIDs include firmware capable of receiving feedback from all the temperature sensors, processing the feedback, and issuing commands to the heater 130 and/or the pre-heater A in response to the feedback.

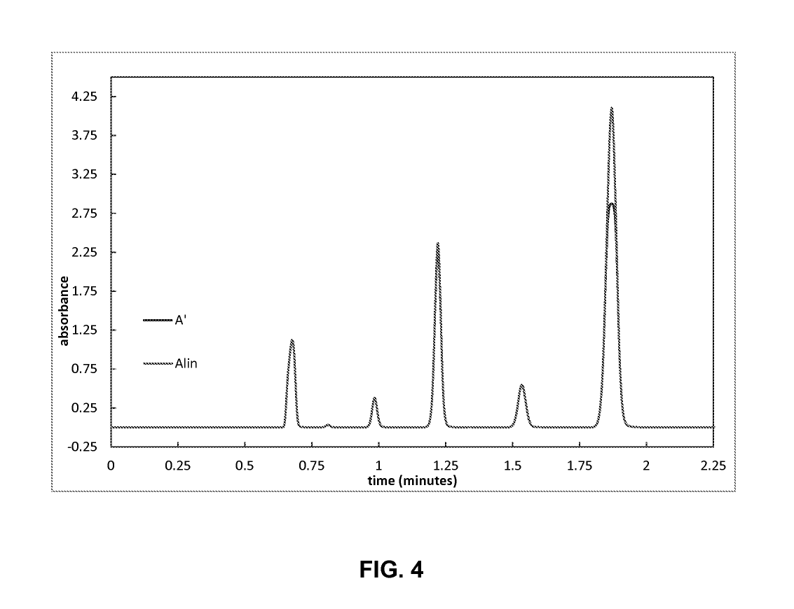

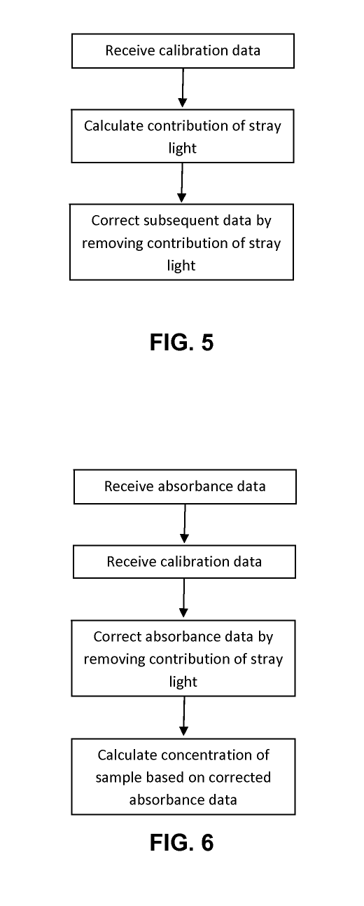

FIG. 4 is a flow diagram 400 of a method for controlling the temperature of a chromatography column. The method includes the steps of: directly measuring (401) the temperature of a chromatography column; and heating (402) a solvent in response to the measured temperature to control the temperature of the chromatography column.

Optionally, the step of heating (401) can include contact heating, e.g., thermoelectric (Peltier) heating. In some implementations, the step of heating (401) includes non-contact heating, e.g., inductive or infrared heating. The temperature of a chromatography column, for most of chromatography applications, is typically in a range of about 4 degrees Centigrade to about 90 degrees Centigrade.

Although a number of implementations have been described in detail above, other modifications, variations and implementations are possible in light of the foregoing teaching. For example, though, as described above, non-contact sensors are used to directly measure the temperature of a chromatography column, they can also be applied to other devices in a chromatography system, for example, to a sample chamber or a fluidic conduit.

One of ordinary skill in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. An apparatus for controlling the temperature of a chromatography column, comprising:
a thermal-isolation vessel;
a heater in thermal communication with the chromatography column, the heater disposed on the thermal-isolation vessel;
a temperature sensor disposed to directly measure the temperature of the chromatography column; and
a control unit in signal communication with the temperature sensor, the control unit configured to control the heater, in response to direct measurement of the temperature of the column by the temperature sensor.

2. The apparatus of claim 1, wherein the temperature sensor is disposed in contact with the chromatography column.

3. The apparatus of claim 1, wherein the temperature sensor is a non-contact temperature sensor.

4. The apparatus of claim 3, wherein the non-contact temperature sensor is an infrared temperature sensor.

5. The apparatus of claim 4 further comprising a target of known emissivity attached to the chromatography column.

6. The apparatus of claim 4 further comprising an infrared-transmissive material disposed to protect the infrared temperature sensor.

7. The apparatus of claim 1 further comprising additional temperature sensors disposed to directly measure the temperature of the chromatography column.

8. The apparatus of claim 1, wherein the temperature sensor directly measures the temperature at the midpoint of the chromatography column.

9. The apparatus of claim 1 wherein the heater comprises a pre-heater on thermal-isolation vessel.

10. The apparatus of claim 1 further comprising at least one temperature sensor disposed to measure the temperature of the thermal-isolation vessel.

11. The apparatus of claim 1 further comprising at least one temperature sensor disposed to measure the temperature of the heater.

12. A method of controlling the temperature of a chromatography column, comprising:
directly measuring the temperature of the chromatography column; and
heating a solvent in response to the measured temperature to control the temperature of the chromatography column.
